(19) United States
(12) Patent Application Publication
(10) Pub. No.: US 2018/0035435 A1
(43) Pub. Date: Feb. 1, 2018

(54) MECHANISMS FOR INTERFERENCE MANAGEMENT OF MULTI-TTI SIDELINK-CENTRIC SUBFRAMES IN WIRELESS COMMUNICATION

(71) Applicant: QUALCOMM Incorporated, San Diego, CA (US)

(72) Inventors: Piyush Gupta, Bridewater, NJ (US); Junyi Li, Chester, NJ (US); Chong Li, Weehawken, NJ (US)

(21) Appl. No.: 15/411,917

(22) Filed: Jan. 20, 2017

Related U.S. Application Data
(60) Provisional application No. 62/367,346, filed on Jul. 27, 2016.

(51) Int. Cl. H04W 72/08; H04W 72/12; H04L 5/00; H04W 72/04

(52) U.S. Cl. CPC H04W 72/082; H04W 72/046; H04W 72/0446; H04W 72/1226; H04L 5/0055

(57) ABSTRACT

Aspects of the present disclosure provide solutions that can mitigate interference between sidelinks. A user equipment (UE) can directly communicate with another device using a sidelink or sidelink channel without necessarily relying on a scheduling entity (e.g., a base station). The UE may transmit a direction selection signal (DSS) to another sidelink entity to indicate a requested duration of time to keep a first sidelink available for a plurality of transmission time intervals. The UE may perform various processes to mitigate interference between the first sidelink and a second sidelink established between other sidelink entities. To mitigate interference between sidelinks, for example, the UE may puncture its sidelink data during a time period that overlaps with a destination receive signal (DRS) of another sidelink. In another example, the UE may receive a retransmission of a DRS that may not be received due to sidelink interference.

### PRIORITY CLAIM

This application claims priority to and the benefit of provisional patent application No. 62/367,346 filed in the United States Patent and Trademark Office on 27 Jul. 2016, the entire content of which is incorporated herein by reference as if fully set forth below in its entirety and for all applicable purposes.

### TECHNICAL FIELD

The technology discussed herein relates, generally, to wireless communication systems, and, more particularly, to using sidelink-centric subframes for wireless communication.

### INTRODUCTION

Wireless communication networks are widely deployed to provide various communication services such as telephony, video, data, messaging, broadcasts, and so on. Such networks, which are usually multiple access networks, support communication for multiple users by sharing the available network resources. Within such wireless networks a variety of data services may be provided, including voice, video, online access, and emails. The spectrum allocated to such wireless communication networks can include licensed spectrum and/or unlicensed spectrum. As the demand for mobile broadband access continues to increase, research and development continue to advance wireless communication technologies not only to meet the growing demand for mobile broadband access, but also to advance and enhance the user experience with mobile communications.

A user equipment (UE) may have the ability to communicate directly with another UE without relaying such communication through a network node or base station, such as an evolved Node B (eNB) or scheduling entity. However, in some circumstances, UE-to-UE or peer-to-peer communications may potentially interfere with eNB-to-UE communications and/or other UE-to-UE communications. Interference management in such circumstances may enhance communication efficiency and throughput, thereby improving the overall user experience.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide solutions that can mitigate interference between sidelinks. A user equipment (UE) can directly communicate with another device using a sidelink or sidelink channel without necessarily relying on a scheduling entity (e.g., a base station). The UE may perform various processes to mitigate interference between sidelinks established between different sidelink entities.

One aspect of the disclosure provides a method of communication by an apparatus. The apparatus receives, from a scheduling entity, sidelink grant information in a downlink control channel. The apparatus further transmits a direction selection signal (DSS) in a first transmission time interval (TTI) utilizing a first sidelink to a first scheduled entity according to the sidelink grant information. The DSS is configured to indicate a requested duration of time to keep the first sidelink available for a plurality of TTIs including the first TTI. The apparatus further mitigates interference between the first sidelink and a second sidelink established between other scheduled entities different from the first scheduled entity. To mitigate interference, the apparatus may puncture sidelink data of the first sidelink during a first time period of at least one of the TTIs, wherein the first time period overlaps with a first destination receive signal (DRS) of the second sidelink. To mitigate interference, the apparatus may receive, from the first scheduled entity in the first TTI, a retransmission of a second DRS in a second time period that is not interfered by the second sidelink.

Another aspect of the disclosure provides an apparatus for wireless communication. The apparatus includes a communication interface configured to communicate with a scheduling entity, a first scheduled entity, and a second scheduled entity. The apparatus further includes a memory stored with executable code and a processor operatively coupled with the communication interface and the memory. The processor is configured by the executable code to receive, from the scheduling entity, sidelink grant information in a downlink control channel. The processor is further configured to transmit a direction selection signal (DSS) in a first transmission time interval (TTI) utilizing a first sidelink to the first scheduled entity according to the sidelink grant information, wherein the DSS is configured to indicate a requested duration of time to keep the first sidelink available for a plurality of TTIs including the first TTI. The apparatus is further configured to mitigate interference between the first sidelink and a second sidelink established between other scheduled entities different from the first scheduled entity. To mitigate interference, the processor may be configured to puncture sidelink data of the first sidelink during a first time period of at least one of the TTIs, wherein the first time period overlaps with a first destination receive signal (DRS) of the second sidelink. To mitigate interference, the processor may be configured to receive, from the first scheduled entity in the first TTI, a retransmission of a second DRS in a second time period that is not interfered by the second sidelink.

Another aspect of the disclosure provides an apparatus for wireless communication. The apparatus includes means for receiving, from a scheduling entity, sidelink grant information in a downlink control channel. The apparatus further includes means for transmitting a direction selection signal (DSS) signal in a first transmission time interval (TTI) utilizing a first sidelink to a first scheduled entity according to the sidelink grant information, wherein the DSS is configured to indicate a requested duration of time to keep the first sidelink available for a plurality of TTIs including the first TTI. The apparatus further includes means for mitigating interference between the first sidelink and a second sidelink established between other scheduled entities different from the first scheduled entity. The means for mitigating interference may be configured to puncture sidelink data of the first sidelink during a first time period of at least one of the TTIs, wherein the first time period overlaps with a first destination receive signal (DRS) of the second sidelink. The means for mitigating interference may be configured to receive, from the first scheduled entity in the first TTI, a retransmission of a second DRS in a second time period that is not interfered by the second sidelink.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of an access network according to some aspects of the present disclosure.

FIG. 2 is a diagram conceptually illustrating an example of a scheduling entity communicating with one or more scheduled entities according to some aspects of the present disclosure.

FIG. 3 is a diagram illustrating an example of a hardware implementation for a scheduling entity according to some aspects of the present disclosure.

FIG. 4 is a diagram illustrating an example of a hardware implementation for a scheduled entity according to some aspects of the present disclosure.

FIG. 5 is a diagram illustrating an example of a downlink (DL)-centric subframe according to some aspects of the present disclosure.

FIG. 6 is a diagram illustrating an example of an uplink (UL)-centric subframe according to some aspects of the present disclosure.

FIG. 7 is a diagram illustrating an example of a sidelink-centric subframe according to some aspects of the present disclosure.

FIG. 8 is a diagram illustrating an example of sidelink-centric subframes extending across a plurality of transmission time intervals (TTIs) according to some aspects of the present disclosure.

FIG. 9 is a diagram illustrating another example of a sidelink-centric subframe according to some aspects of the present disclosure.

FIG. 10 is a diagram illustrating another example of sidelink-centric subframes extending across a plurality of TTIs according to some aspects of the present disclosure.

FIG. 11 is a diagram illustrating yet another example of sidelink-centric subframes extending across a plurality of TTIs.

FIG. 12 is a diagram illustrating an interference scenario between sidelink-centric subframes extending across multiple TTIs.

FIG. 13 is a diagram illustrating an example of a destination receive signal (DRS) protection scheme using data puncturing according to some aspects of the present disclosure.

FIG. 14 is a diagram illustrating an example of data puncturing process according to some aspects of the present disclosure.

FIG. 15 is a diagram illustrating an example of a DRS protection scheme using retransmission according to some aspects of the present disclosure.

FIG. 16 is a flowchart illustrating a method of sidelink interference management according to some aspects of the present disclosure.

FIG. 17 is a flowchart illustrating another method of sidelink interference management according to some aspects of the present disclosure.

FIG. 18 is a flowchart illustrating still another method of sidelink interference management according to some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the present disclosure provide solutions that can mitigate interference between sidelinks. A user equipment (UE) can directly communicate with another device using a sidelink or sidelink channel without necessarily relying on a scheduling entity (e.g., a base station). The UE may transmit a direction selection signal (DSS) to another sidelink entity to indicate a requested duration of time to keep a first sidelink available for a plurality of transmission time intervals. The UE may perform various processes to mitigate interference between the first sidelink and a second sidelink established between other sidelink entities. To mitigate interference between sidelinks, for example, the UE may puncture its sidelink data during a time period that overlaps with a destination receive signal (DRS) of another sidelink. In another example, the UE may receive a retransmission of a DRS that may not be received due to sidelink interference.

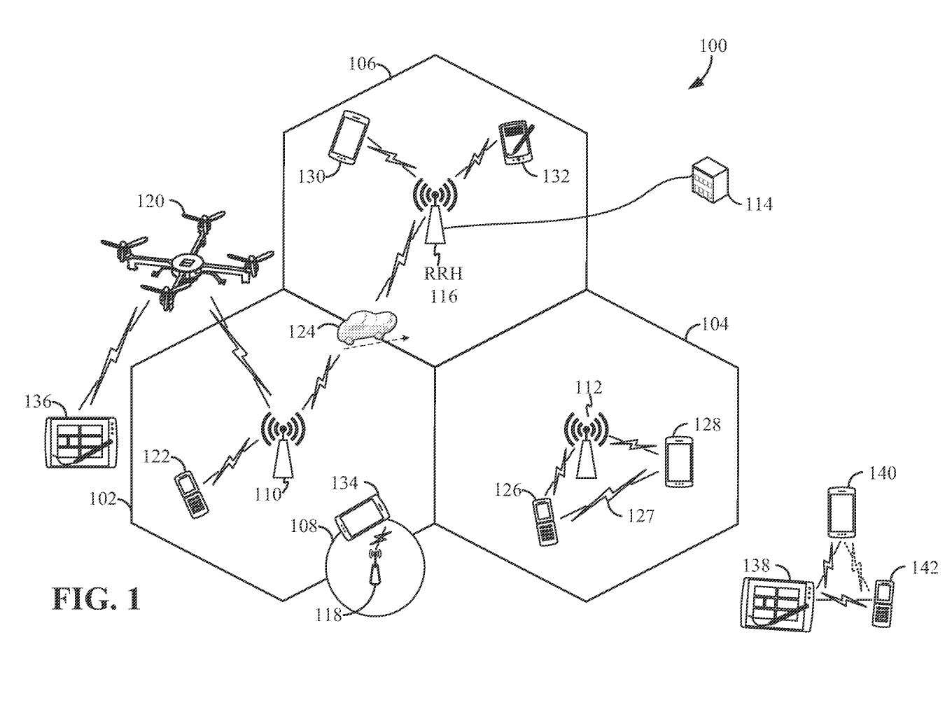

The various concepts presented throughout this disclosure may be implemented across a broad variety of telecommunication systems, network architectures, and communication standards. Referring now to FIG. 1, as an illustrative example without limitation, a schematic illustration of a radio access network 100 is provided.

The geographic region covered by the radio access network 100 may be divided into a number of cellular regions (cells) that can be uniquely identified by a user equipment (UE) based on an identification broadcasted over a geographical area from one access point or base station. FIG. 1 illustrates macrocells 102, 104, and 106, and a small cell 108, each of which may include one or more sectors. A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a base station (BS) serves each cell. Broadly, a base station is a network element in a radio access network responsible for radio transmission and reception in one or more cells to or from a UE. A BS may also be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), or some other suitable terminology.

In FIG. 1, two high-power base stations 110 and 112 are shown in cells 102 and 104; and a third high-power base station 114 is shown controlling a remote radio head (RRH) 116 in cell 106. That is, a base station can have an integrated antenna or can be connected to an antenna or RRH by feeder cables. In the illustrated example, the cells 102, 104, and 106 may be referred to as macrocells, as the high-power base stations 110, 112, and 114 support cells having a large size. Further, a low-power base station 118 is shown in the small cell 108 (e.g., a microcell, picocell, femtocell, home base station, home Node B, home eNode B, etc.) which may overlap with one or more macrocells. In this example, the cell 108 may be referred to as a small cell, as the low-power base station 118 supports a cell having a relatively small size. Cell sizing can be done according to system design as well as component constraints. It is to be understood that the radio access network 100 may include any number of wireless base stations and cells. Further, a relay node may be deployed to extend the size or coverage area of a given cell. The base stations 110, 112, 114, 118 provide wireless access points to a core network for any number of mobile apparatuses.

FIG. 1 further includes a quadcopter or drone 120, which may be configured to function as a base station. That is, in some examples, a cell may not necessarily be stationary, and the geographic area of the cell may move according to the location of a mobile base station such as the quadcopter 120.

In general, base stations may include a backhaul interface for communication with a backhaul portion of the network. The backhaul may provide a link between a base station and a core network, and in some examples, the backhaul may provide interconnection between the respective base stations. The core network is a part of a wireless communication system that is generally independent of the radio access technology used in the radio access network. Various types of backhaul interfaces may be employed, such as a direct physical connection, a virtual network, or the like using any suitable transport network. Some base stations may be configured as integrated access and backhaul (IAB) nodes, where the wireless spectrum may be used both for access links (i.e., wireless links with UEs), and for backhaul links. This scheme is sometimes referred to as wireless self-backhauling. By using wireless self-backhauling, rather than requiring each new base station deployment to be outfitted with its own hard-wired backhaul connection, the wireless spectrum utilized for communication between the base station and UE may be leveraged for backhaul communication, enabling fast and easy deployment of highly dense small cell networks.

The radio access network 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Within the radio access network 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with low-power base station 118; and UE 136 may be in communication with mobile base station 120. Here, each base station 110, 112, 114, 118, and 120 may be configured to provide an access point to a core network (not shown) for all the UEs in the respective cells.

In another example, a mobile network node (e.g., quadcopter 120) may be configured to function as a UE. For example, the quadcopter 120 may operate within cell 102 by communicating with base station 110. In some aspects of the disclosure, two or more UE (e.g., UEs 126 and 128) may communicate with each other using peer to peer (P2P) or sidelink signals 127 without relaying that communication through a base station (e.g., base station 112).

Unicast or broadcast transmissions of control information and/or traffic information from a base station (e.g., base station 110) to one or more UEs (e.g., UEs 122 and 124) may be referred to as downlink (DL) transmission, while transmissions of control information and/or traffic information originating at a UE (e.g., UE 122) may be referred to as uplink (UL) transmissions. In addition, the uplink and/or downlink control information and/or traffic information may be transmitted in transmission time intervals (TTIs). As used herein, the term TTI may refer to the inter-arrival time of a given schedulable set of data. In various examples, a TTI may be configured to carry one or more transport blocks, which are generally the basic data unit exchanged between the physical layer (PHY) and medium access control (MAC) layer (sometimes referred to as a MAC PDU, or protocol data unit). In accordance with various aspects of the present disclosure, a subframe may include one or more TTIs. Thus, as further used herein, the term subframe may refer to an encapsulated set of information including one or more TTIs, which is capable of being independently decoded. Multiple subframes may be grouped together to form a single frame or radio frame. Any suitable number of subframes may occupy a frame. In addition, a subframe may have any suitable duration (e.g., 250 ρs, 500 ρs, 1 ms, etc.).

The air interface in the radio access network 100 may utilize one or more multiplexing and multiple access algorithms to enable simultaneous communication of the various devices. For example, multiple access for uplink (UL) or reverse link transmissions from UEs 122 and 124 to base station 110 may be provided utilizing time division multiple access (TDMA), code division multiple access (CDMA), frequency division multiple access (FDMA), orthogonal frequency division multiple access (OFDMA), sparse code multiple access (SCMA), resource spread multiple access (RSMA), or other suitable multiple access schemes. Further, multiplexing downlink (DL) or forward link transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the radio access network 100 may utilize one or more duplexing algorithms Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some time the channel is dedicated for transmissions in one direction, while at other time the channel is dedicated for transmissions in the other direction, where the direction may change very rapidly, e.g., several times per subframe.

In the radio access network 100, the ability for a UE to communicate while moving, independent of its location, is referred to as mobility. The various physical channels between the UE and the radio access network are generally set up, maintained, and released under the control of a mobility management entity (MME). In various aspects of the disclosure, a radio access network 100 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 124 (illustrated as a vehicle, although any suitable form of UE may be used) may move from the geographic area corresponding to its serving cell 102 to the geographic area corresponding to a neighbor cell 106. When the signal strength or quality from the neighbor cell 106 exceeds that of its serving cell 102 for a given amount of time, the UE 124 may transmit a reporting message to its serving base station 110 indicating this condition. In response, the UE 124 may receive a handover command, and the UE may undergo a handover to the cell 106.

In a network configured for UL-based mobility, UL reference signals from each UE may be utilized by the network to select a serving cell for each UE. In some examples, the base stations 110, 112, and 114/116 may broadcast unified synchronization signals (e.g., unified Primary Synchronization Signals (PSSs), unified Secondary Synchronization Signals (SSSs) and unified Physical Broadcast Channels (PBCH)). The UEs 122, 124, 126, 128, 130, and 132 may receive the unified synchronization signals, derive the carrier frequency and subframe timing from the synchronization signals, and in response to the derived timing, transmit an uplink pilot or reference signal. The uplink pilot signal transmitted by a UE (e.g., UE 124) may be concurrently received by two or more cells (e.g., base stations 110 and 114/116) within the radio access network 100. Each of the cells may measure a strength of the pilot signal, and the radio access network (e.g., one or more of the base stations 110 and 114/116 and/or a central node within the core network) may determine a serving cell for the UE 124. As the UE 124 moves through the radio access network 100, the network may continue to monitor the uplink pilot signal transmitted by the UE 124. When the signal strength or quality of the pilot signal measured by a neighboring cell exceeds that of the signal strength or quality measured by the serving cell, the network 100 may handover the UE 124 from the serving cell to the neighboring cell, with or without informing the UE 124.

Although the synchronization signal transmitted by the base stations 110, 112, and 114/116 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

In some examples, access to the air interface may be scheduled, wherein a scheduling entity (e.g., a base station) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

Base stations are not the only entities that may function as a scheduling entity. That is, in some examples, a UE may function as a scheduling entity, scheduling resources for one or more scheduled entities (e.g., one or more other UEs). In other examples, sidelink signals may be used between UEs without necessarily relying on scheduling or control information from a base station. For example, UE 138 is illustrated communicating with UEs 140 and 142. In some examples, the UE 138 is functioning as a scheduling entity or a primary sidelink device, and UEs 140 and 142 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 140 and 142 may optionally communicate directly with one another in addition to communicating with the scheduling entity 138.

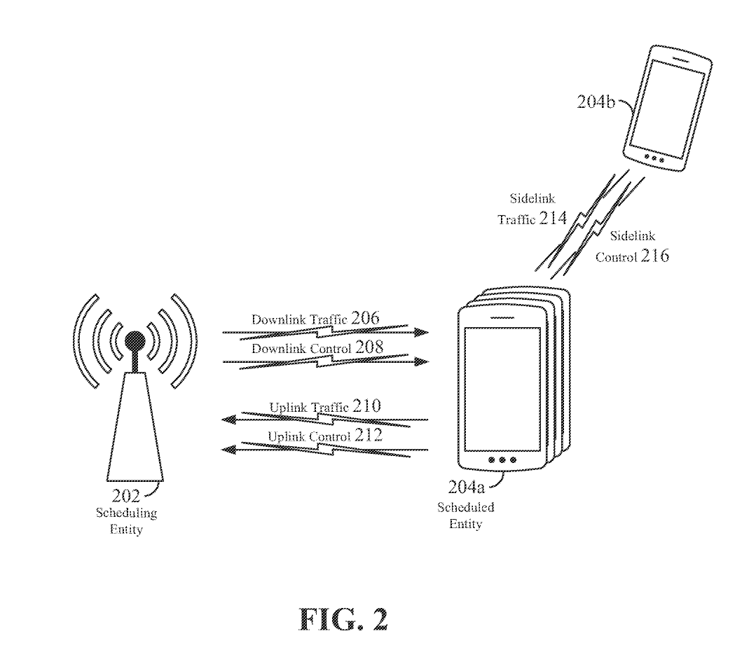

Thus, in a wireless communication network with scheduled access to time-frequency resources and having a cellular configuration, a P2P configuration, or a mesh configuration, a scheduling entity and one or more scheduled entities may communicate utilizing the scheduled resources. Referring now to FIG. 2, a block diagram illustrates a scheduling entity 202 and a plurality of scheduled entities 204 (e.g., 204a and 204b). Here, the scheduling entity 202 may correspond to a base station 110, 112, 114, and/or 118. In additional examples, the scheduling entity 202 may correspond to a UE 138, the quadcopter 120, or any other suitable node in the radio access network 100. Similarly, in various examples, the scheduled entity 204 may correspond to the UE 122, 124, 126, 128, 130, 132, 134, 136, 138, 140, and 142, or any other suitable node in the radio access network 100.

As illustrated in FIG. 2, the scheduling entity 202 may broadcast traffic 206 to one or more scheduled entities 204 (the traffic may be referred to as downlink traffic). In accordance with certain aspects of the present disclosure, the term downlink may refer to a point-to-multipoint transmission originating at the scheduling entity 202. Broadly, the scheduling entity 202 is a node or device responsible for scheduling traffic in a wireless communication network, including the downlink transmissions and, in some examples, uplink traffic 210 from one or more scheduled entities to the scheduling entity 202. Another way to describe the system may be to use the term broadcast channel multiplexing. In accordance with aspects of the present disclosure, the term uplink may refer to a point-to-point transmission originating at a scheduled entity 204. Broadly, the scheduled entity 204 is a node or device that receives scheduling control information, including but not limited to scheduling grants, synchronization or timing information, or other control information from another entity in the wireless communication network such as the scheduling entity 202.

The scheduling entity 202 may broadcast control information 208 including one or more control channels, such as a PBCH; a PSS; a SSS; a physical control format indicator channel (PCFICH); a physical hybrid automatic repeat request (HARQ) indicator channel (PHICH); and/or a physical downlink control channel (PDCCH), etc., to one or more scheduled entities 204. The PHICH carries HARQ feedback transmissions such as an acknowledgment (ACK) or negative acknowledgment (NACK). HARQ is a technique well-known to those of ordinary skill in the art, wherein packet transmissions may be checked at the receiving side for accuracy, and if confirmed, an ACK may be transmitted, whereas if not confirmed, a NACK may be transmitted. In response to a NACK, the transmitting device may send a HARQ retransmission, which may implement chase combining, incremental redundancy, etc.

Uplink traffic 210 and/or downlink traffic 206 including one or more traffic channels, such as a physical downlink shared channel (PDSCH) or a physical uplink shared channel (PUSCH) (and, in some examples, system information blocks (SIBs)), may additionally be transmitted between the scheduling entity 202 and the scheduled entity 204. Transmissions of the control and traffic information may be organized by subdividing a carrier, in time, into suitable transmission time intervals (TTIs). For example, a TTI may correspond to an encapsulated set or packet of information capable of being independently decoded. In various examples, TTIs may correspond to frames, subframes, data blocks, time slots, or other suitable groupings of bits for transmission.

Furthermore, the scheduled entities 204 may transmit uplink control information 212 including one or more uplink control channels to the scheduling entity 202. Uplink control information may include a variety of packet types and categories, including pilots, reference signals, and information configured to enable or assist in decoding uplink traffic transmissions. In some examples, the control information 212 may include a scheduling request (SR), i.e., request for the scheduling entity 202 to schedule uplink transmissions. Here, in response to the SR transmitted on the control channel 212, the scheduling entity 202 may transmit downlink control information 208 (e.g., grants) that may schedule the TTI for uplink packet transmissions.

Uplink and downlink transmissions may generally utilize a suitable error correcting block code. In a typical block code, an information message or sequence is split up into blocks, and an encoder at the transmitting device then mathematically adds redundancy to the information message. Exploitation of this redundancy in the encoded information message can improve the reliability of the message, enabling correction for any bit errors that may occur due to the noise. Some examples of error correcting codes include Hamming codes, Bose-Chaudhuri-Hocquenghem (BCH) codes, turbo codes, low-density parity check (LDPC) codes, and polar codes. Various implementations of scheduling entities 202 and scheduled entities 204 may include suitable hardware and capabilities (e.g., an encoder and/or decoder) to utilize any one or more of these error correcting codes for wireless communication.

In some examples, scheduled entities such as a first scheduled entity 204a and a second scheduled entity 204b may utilize sidelink signals for direct D2D communication. Sidelink signals may include sidelink traffic 214 and sidelink control 216. Sidelink control information 216 may include a source transmit signal (STS), a direction selection signal (DSS), a destination receive signal (DRS), and a physical sidelink HARQ indicator channel (PSHICH). The STS/DSS may provide for a scheduled entity 204 to request a duration of time to keep a sidelink channel available for a sidelink signal; and the DRS may provide for the scheduled entity 204 to indicate the availability of the sidelink channel, e.g., for a requested duration of time. An exchange of DSS/STS and DRS signals (e.g., handshake) may enable different scheduled entities performing sidelink communications to negotiate the availability of the sidelink channel prior to communication of the sidelink traffic information 214. The PSHICH may include HARQ acknowledgment information and/or a HARQ indicator from a destination device, so that the destination may acknowledge data received from a source device.

The channels or carriers illustrated in FIG. 2 are not necessarily all of the channels or carriers that may be utilized between a scheduling entity 202 and scheduled entities 204, and those of ordinary skill in the art will recognize that other channels or carriers may be utilized in addition to those illustrated, such as other traffic, control, and feedback channels.

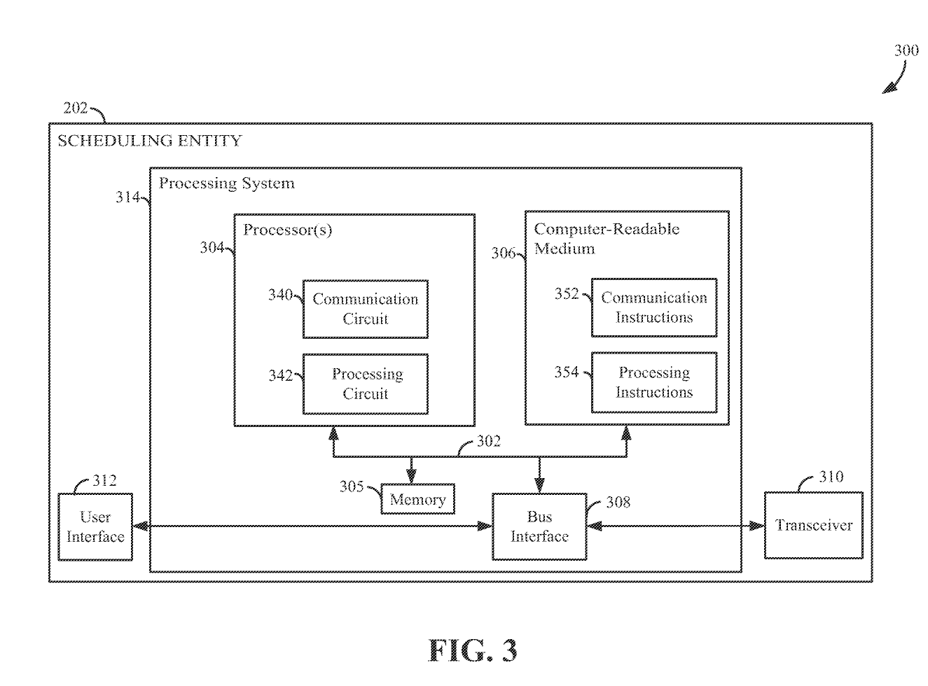

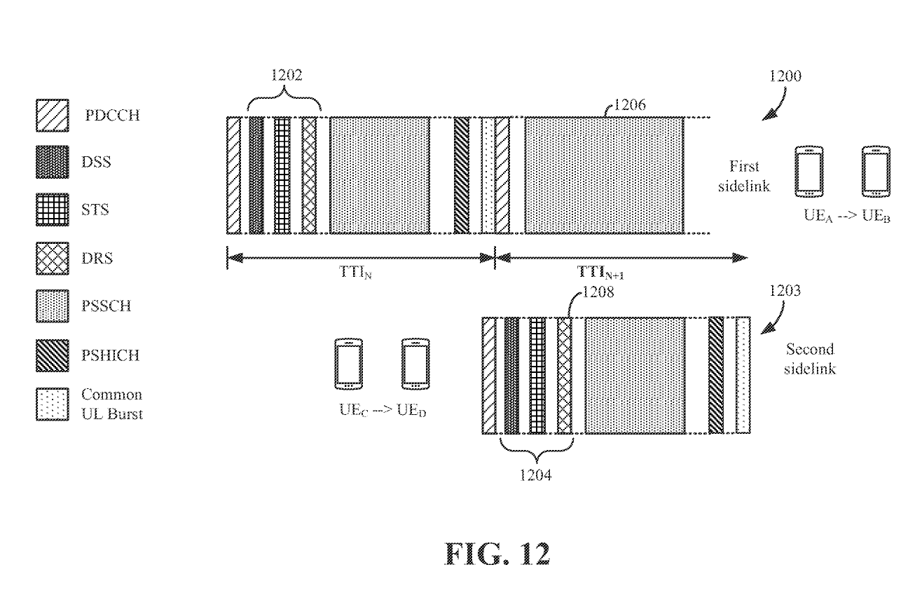

FIG. 3 is a diagram illustrating an example of a hardware implementation 300 for scheduling entity 202 according to aspects of the present disclosure. Scheduling entity 202 may employ a processing system 314. Scheduling entity 202 may be implemented with a processing system 314 that includes one or more processors 304. Examples of processors 304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, scheduling entity 202 may be configured to perform any one or more of the functions described herein. That is, the processor 304, as utilized in scheduling entity 202, may be used or configured to implement any one or more of the processes described herein, for example, in FIGS. 12-18.

In this example, the processing system 314 may be implemented with a bus architecture, represented generally by the bus 302. The bus 302 may include any number of interconnecting buses and bridges depending on the specific application of the processing system 314 and the overall design constraints. The bus 302 communicatively couples together various circuits including one or more processors (represented generally by the processor 304), a memory 305, and computer-readable media (represented generally by the computer-readable medium 306). The bus 302 may also link various other circuits such as timing sources, peripherals, voltage regulators, and power management circuits. A bus interface 308 provides an interface between the bus 302 and a transceiver 310. The transceiver 310 provides a communication interface or a means for communicating with various other apparatuses over a transmission medium. Depending upon the nature of the apparatus, a user interface 312 (e.g., keypad, display, speaker, microphone, joystick) may also be provided.

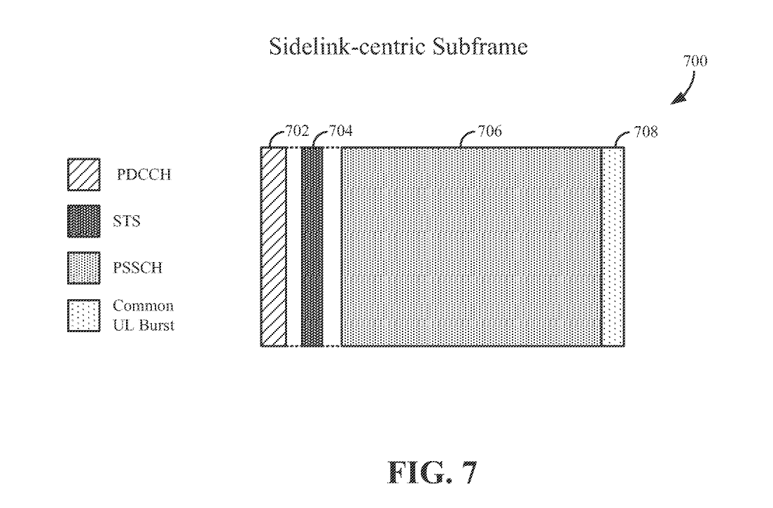

At least one processor 304 is responsible for managing the bus 302 and general processing, including the execution of software stored on the computer-readable medium 306. The software, when executed by the processor 304, causes the processing system 314 to perform the various functions described below for any particular apparatus. The computer-readable medium 306 and the memory 305 may also be used for storing data that is manipulated by the processor 304 when executing software. In some aspects of the disclosure, the computer-readable medium 306 may include communication instructions 352. The communication instructions 352 may include instructions for performing various operations related to wireless communication (e.g., signal reception and/or signal transmission) as described herein. For example, the communication instructions 352 may include code for configuring the processing system 314 and communication interface 310 to communicate and control a plurality of scheduled entities using sidelink communication. In some aspects of the disclosure, the computer-readable medium 306 may include processing instructions 354. The processing instructions 354 may include instructions for performing various operations related to signal processing (e.g., processing a received signal and/or processing a signal for transmission) as described herein. In one example, the processing instructions 354 include code that may be executed by the processor 304 to control and schedule sidelink communication as described in FIGS. 7-18.

At least one processor 304 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 306. The computer-readable medium 306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 306 may reside in the processing system 314, external to the processing system 314, or distributed across multiple entities including the processing system 314. The computer-readable medium 306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, at least one processor 304 may include a communication circuit 340. The communication circuit 340 may include one or more hardware components that provide the physical structure that performs various processes related to wireless communication (e.g., signal reception and/or signal transmission) as described herein. For example, the communication circuit 340 may be configured to control and schedule sidelink communication among a plurality of scheduled entities. The communication circuit 340 may transmit or broadcast sidelink grants or control information to the scheduled entities using a downlink control channel (e.g., PDCCH) via the communication interface 310. In some examples, the sidelink control information may be configured to mitigate interference between sidelinks as described in FIGS. 12-18. In some aspects of the disclosure, the processor 304 may also include a processing circuit 342. The processing circuit 342 may include one or more hardware components that provide the physical structure that performs various processes related to signal processing (e.g., processing a received signal and/or processing a signal for transmission) as described herein. The circuitry included in the processor 304 is provided as non-limiting examples. Other means for carrying out the described functions exists and is included within various aspects of the present disclosure. In some aspects of the disclosure, the computer-readable medium 306 may store computer-executable code comprising instructions configured to perform various processes described herein. The instructions included in the computer-readable medium 306 are provided as non-limiting examples. Other instructions configured to carry out the described functions exist and are included within various aspects of the present disclosure.

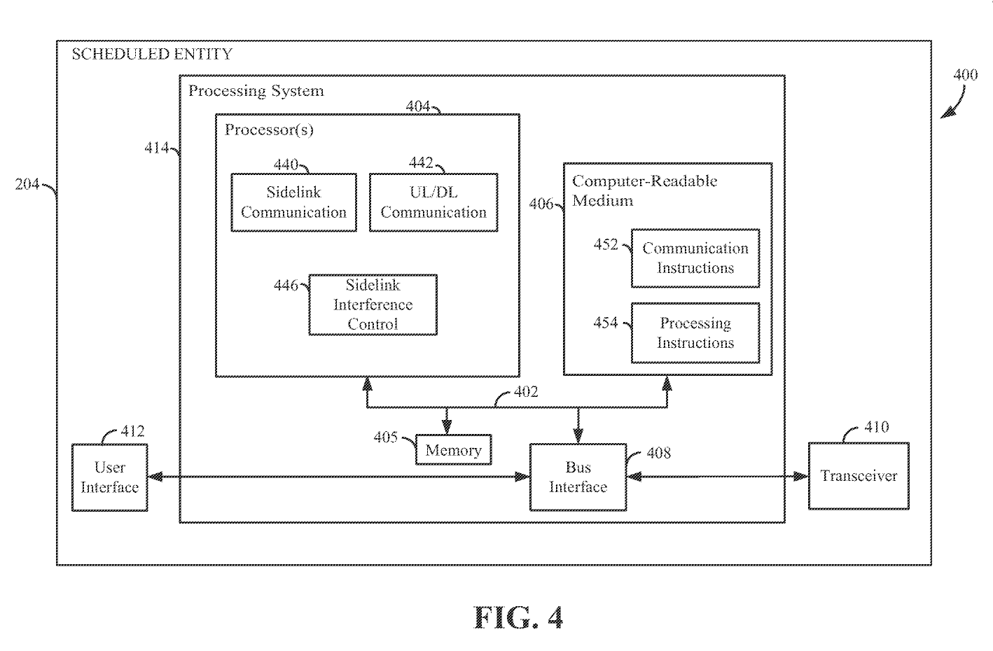

FIG. 4 is a diagram illustrating an example of a hardware implementation 400 for a scheduled entity 204 according to aspects of the present disclosure. Scheduled entity 204 may employ a processing system 414. Scheduled entity 204 may be implemented with a processing system 414 that includes one or more processors 404. Examples of processors 404 include microprocessors, microcontrollers, DSPs, FPGAs, PLDs, state machines, gated logic, discrete hardware circuits, and other suitable hardware configured to perform the various functionality described throughout this disclosure. In various examples, scheduled entity 204 may be configured to perform any one or more of the functions described herein. That is, the processor 404, as utilized in scheduled entity 204, may be used or configured to implement any one or more of the processes and methods described herein, for example, in FIGS. 12-18.

In this example, the processing system 414 may be implemented with a bus architecture, represented generally by the bus 402. The bus 402 may include any number of interconnecting buses and bridges depending on the specific application of the processing system 414 and the overall design constraints. The bus 402 communicatively couples together various circuits including one or more processors (represented generally by the processor 404), a memory 405, and computer-readable media (represented generally by the computer-readable medium 406). The bus 402 may also link various other circuits such as timing sources, peripherals, voltage regulators, and power management circuits. A bus interface 408 provides an interface between the bus 402 and a transceiver 410. The transceiver 410 provides a communication interface or a means for communicating with various other apparatuses over a transmission medium. Depending upon the nature of the apparatus, a user interface 412 (e.g., keypad, display, speaker, microphone, joystick) may also be provided.

At least one processor 404 is responsible for managing the bus 402 and general processing, including the execution of software stored on the computer-readable medium 406. The software, when executed by the processor 404, causes the processing system 414 to perform the various functions described below for any particular apparatus. The computer-readable medium 406 and the memory 405 may also be used for storing data that is manipulated by the processor 404 when executing software. In some aspects of the disclosure, the computer-readable medium 406 may include communication instructions 452. The communication instructions 452 may include instructions for performing various operations related to wireless communication (e.g., signal reception and/or signal transmission) as described herein. In some aspects of the disclosure, the instructions 452 may include code for configuring the scheduled entity to perform sidelink communication as described in relation to FIGS. 12-18. In some aspects of the disclosure, the computer-readable medium 406 may include processing instructions 454. The processing instructions 454 may include instructions for performing various operations related to signal processing (e.g., processing a received signal and/or processing a signal for transmission) as described herein. In some aspects of the disclosure, the processing instructions 454 may include code for configuring the scheduled entity to perform sidelink communication as described in relation to FIGS. 12-18.

At least one processor 404 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 406. The computer-readable medium 406 may be a non-transitory computer-readable medium. A non-transitory computer-readable medium includes, by way of example, a magnetic storage device (e.g., hard disk, floppy disk, magnetic strip), an optical disk (e.g., a CD or a DVD), a smart card, a flash memory device (e.g., a card, a stick, or a key drive), a RAM, a ROM, a PROM, an EPROM, an EEPROM, a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 406 may reside in the processing system 414, external to the processing system 414, or distributed across multiple entities including the processing system 414. The computer-readable medium 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, at least one processor 404 may include a communication circuit 440. The communication circuit 440 may include one or more hardware components that provide the physical structure that performs various processes related to wireless communication (e.g., signal reception and/or signal transmission) as described herein. In some aspects of the disclosure, the processor 404 may also include a processing circuitry that include one or more hardware components that provide the physical structure that performs various processes related to signal processing (e.g., processing a received signal and/or processing a signal for transmission) as described herein. In some aspects of the disclosure, the processor 404 may include a sidelink communication block 440, an uplink/downlink (UL/DL) communication block 442, and a sidelink interference control block 446. The sidelink communication block 440 may be configured to perform various sidelink communication processes and functions as described in relation to FIGS. 7-18. The UL/DL communication block 442 may be configured to perform UL/DL communication with a scheduling entity 202 as described in FIGS. 7-18. The sidelink interference control block 446 may be configured to perform sidelink interference mitigation processes and functions as described in relation to FIGS. 7-18.

The circuitry included in the processor 404 is provided as non-limiting examples. Other means for carrying out the described functions exists and is included within various aspects of the present disclosure. In some aspects of the disclosure, the computer-readable medium 406 may store computer-executable code comprising instructions configured to perform various processes described herein. The instructions included in the computer-readable medium 406 are provided as non-limiting examples. Other instructions configured to carry out the described functions exist and are included within various aspects of the present disclosure.

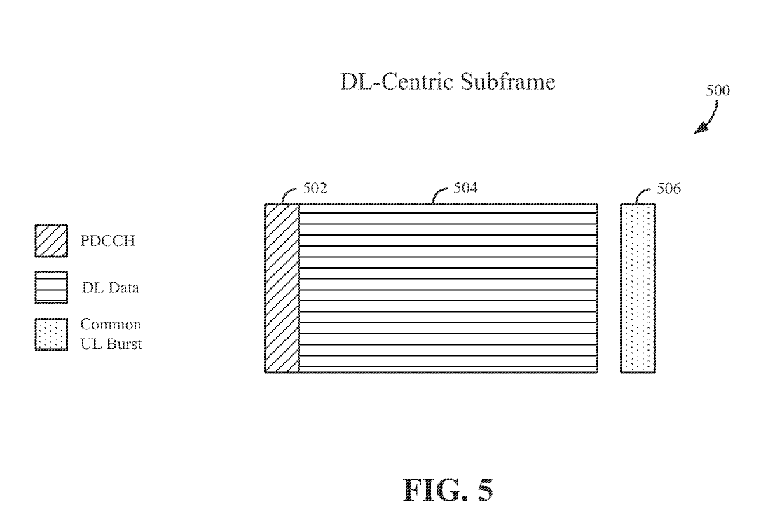

According to various aspects of the disclosure, wireless communication may be implemented by dividing transmissions, in time, into frames, wherein each frame may be further divided into subframes. These subframes may be DL-centric, UL-centric, or sidelink-centric, as described below. For example, FIG. 5 is a diagram showing an example of a DL-centric subframe 500, so called because a majority (or, in some examples, a substantial portion) of the subframe includes DL data. The DL-centric subframe may include a control portion 502. The control portion 502 may exist in the initial or beginning portion of the DL-centric subframe 500. The control portion 502 may include various scheduling information and/or control information corresponding to various portions of the DL-centric subframe. In some configurations, the control portion 502 may include a physical DL control channel (PDCCH), as indicated in FIG. 5. Additional description related to the PDCCH is provided further below with reference to various other drawings. The DL-centric subframe may also include a DL data portion 504. The DL data portion 504 may sometimes be referred to as the payload, traffic, or data portion of the DL-centric subframe. The DL data portion 504 may include the communication resources utilized to communicate DL data from the scheduling entity 202 (e.g., eNB) to the scheduled entity 204 (e.g., UE). In some configurations, the DL data portion 504 may be a physical DL shared channel (PDSCH).

The DL-centric subframe may also include a common UL portion 506. The common UL portion 506 may sometimes be referred to as an UL burst, a common UL burst, and/or various other suitable terms. The common UL portion 506 may include feedback information corresponding to various other portions of the DL-centric subframe. For example, the common UL portion 506 may include feedback information corresponding to the control portion 502 and/or DL data portion 504. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information. As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the scheduled entity 204 (e.g., UE)) to UL communication (e.g., transmission by the scheduled entity 204 (e.g., UE)). One of ordinary skill in the art will understand that the foregoing is merely one example of a DL-centric subframe and alternative structures having similar features may exist without necessarily deviating from the aspects described herein.

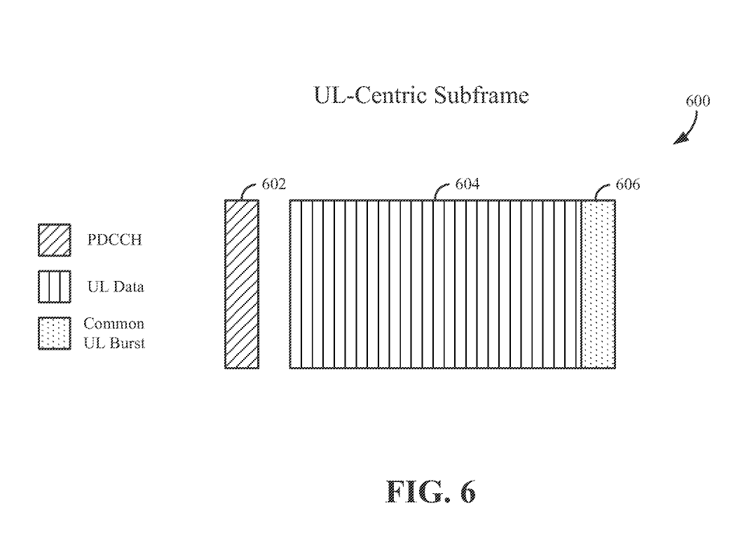

FIG. 6 is a diagram 600 showing an example of an UL-centric subframe, so called because a majority (or, in some examples, a substantial portion) of the subframe includes UL data. The UL-centric subframe may include a control portion 602. The control portion 602 may exist in the initial or beginning portion of the UL-centric subframe. The control portion 602 in FIG. 6 may be similar to the control portion 502 described above with reference to FIG. 5. The UL-centric subframe may also include an UL data portion 604. The UL data portion 604 may sometimes be referred to as the payload, traffic, or data portion of the UL-centric subframe. The UL data portion 604 may include the communication resources utilized to communicate UL data from the scheduled entity 204 (e.g., UE) to the scheduling entity 202 (e.g., eNB). In some configurations, the control portion 602 may include a physical UL shared channel (PUSCH). As illustrated in FIG. 6, the end of the control portion 602 may be separated in time from the beginning of the UL data portion 604. This time separation may sometimes be referred to as a gap, guard period, guard interval, and/or various other suitable terms. This separation or time gap provides time for the switch-over from DL communication (e.g., reception operation by the scheduled entity 204 (e.g., UE)) to UL communication (e.g., transmission by the scheduled entity 204 (e.g., UE)). The UL-centric subframe may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric subframe, and alternative structures having similar features may exist without necessarily deviating from the aspects described herein.

In some circumstances, two or more scheduled entities 204 (e.g., UEs) may communicate with each other using sidelink signals. Generally, a sidelink signal may refer to a signal communicated from one scheduled entity 204 (e.g., UE₁) to another scheduled entity 204 (e.g., UE₂) without relaying that communication through the scheduling entity 202 (e.g., eNB or base station), even though the scheduling entity 202 (e.g., eNB) may be utilized for scheduling and/or control purposes. In some examples, the sidelink signals may be communicated using a licensed spectrum (unlike wireless local area networks, which typically use an unlicensed spectrum). Real-world applications of such sidelink communications may include public safety, proximity services, UE-to-network relaying, vehicle-to-vehicle (V2V) communications, Internet of Everything (IoE) communications, Internet of Things (IoT) communications, mission-critical mesh, and/or various other suitable applications.

However, communication using sidelink signals may increase the relative likelihood of signal interference in certain circumstances. For example, without the aspects described in the present disclosure, interference may occur between the sidelink signals and the DL/UL control/scheduling information of nominal traffic (e.g., communication between a scheduled entity and a scheduling entity). That is, the DL/UL control/scheduling information of nominal traffic may not be as well protected. As another example, without the aspects described in the present disclosure, interference may occur between sidelink signals or channels originating from different scheduled entities 204 (e.g., UEs). That is, concurrently transmitted sidelink signals may collide and/or interfere with each other. Aspects of the present disclosure provide for an interference management scheme for concurrent sidelink signals and sidelink-centric subframes that facilitate sidelink interference management.

FIG. 7 is a diagram illustrating an example of a sidelink-centric subframe 700 according to some aspects of the present disclosure. In some configurations, this sidelink-centric subframe may be utilized for broadcast communication. A broadcast communication may refer to a transmission by one scheduled entity 204b (e.g., UE₁) to a group of scheduled entities 204a (e.g., UE₂-UE_{N}). In this example, the sidelink-centric subframe includes a control portion 702, which may include a PDCCH or a downlink control channel. In some aspects, the control portion 702 may be similar to the control portion 502 (e.g., PDCCH) described in greater detail above with reference to FIG. 5. Additionally or alternatively, the control portion 702 may include grant information related to the sidelink signal or sidelink communication. The grant information may indicate the resource (e.g., time and/or frequency resources) assignment used for sidelink communication, modulation and coding scheme (MCS), multiple-input and multiple-output (MIMO) configuration (if used), etc. Non-limiting examples of grant information may include generic grant information and link-specific grant information. Link-specific grant information may refer to information that enables a specific sidelink communication to occur between two particular scheduled entities 204 (e.g., UEs). In comparison, generic grant information may refer to information that generally enables sidelink communications to occur within a particular cell, without specifying a particular sidelink communication.

Notably, as illustrated in FIG. 7, the control portion 702 may be included in the beginning or initial portion of the sidelink-centric subframe. By including the control portion 702 in the beginning or initial portion of the sidelink-centric subframe, the likelihood of interfering with the control portions 502, 602 of DL-centric and UL-centric subframes of nominal traffic is minimized or reduced. In other words, because the DL-centric subframe, the UL-centric subframe, and the sidelink-centric subframe have their DL control information communicated during a common portion of their respective subframes, the likelihood of interference between the DL control information and the sidelink signals is minimized or reduced. That is, the control portions 502, 602 of DL-centric and UL-centric subframes (of nominal traffic) are relatively better protected.

The sidelink-centric subframe 700 may also include a source transmit signal (STS) portion 704. The STS portion 704 may be a portion of the subframe during which one scheduled entity 204 (e.g., UE) communicates an STS indicating a requested duration of time to keep a sidelink channel available for a sidelink signal or communication. One of ordinary skill in the art will understand that the STS may include additional or alternative various information without necessarily deviating from the scope of the present disclosure. In some configurations, the STS may include a group destination identifier (ID). The group destination ID may correspond to a group of devices or scheduled entities that are intended to receive the STS. In some configurations, the STS may include a specific destination ID that corresponds to a predetermined device or scheduled entity. In some configurations, the STS may indicate a duration of the sidelink transmission, a reference signal to enable channel estimation and RX-yielding, a modulation and coding scheme (MCS) indicator, and/or various other information.

For the sake of completeness, the following information is provided regarding RX-yielding. It is assumed that two sidelinks exist simultaneously. Sidelink₁ is between UE_{A} and UE_{B}, and Sidelink₂ is between UE_{C} and UE_{D}. Assume also that Sidelink₁ has a higher priority than Sidelink₂. If UE_{A} and UE_{C} concurrently transmit their STSs, UE_{D} will refrain from transmitting a DRS, because Sidelink₁ has a higher priority than Sidelink₂. Accordingly, the relatively lower priority sidelink (Sidelink₂) yields (i.e., RX-yielding) communication of the DRS under these circumstances.

A scheduled entity 204 (e.g., UE₁) may transmit an STS (with RX-yielding) to one or more other scheduled entities 204 (e.g., UE₂, UE₃) to request that the other scheduled entities 204 (e.g., UE₂, UE₃) refrain from using the sidelink channel for the requested duration of time, thereby leaving the sidelink channel available for that scheduled entity 204 (e.g., UE₁). By transmitting the STS, the scheduled entity 204 (e.g., UE₁) can effectively reserve the sidelink channel for sidelink communication. This enables distributed scheduling and management of interference that might otherwise occur from another sidelink communication from other scheduled entities 204 (e.g., UE₂, UE₃). Put another way, because the other scheduled entities 204 (e.g., UE₂, UE₃) are informed that UE₁ will be transmitting for the requested period of time, the likelihood of interference between sidelink signals is reduced.

The sidelink-centric subframe 700 may also include a sidelink data portion 706. The sidelink data portion 706 may sometimes be referred to as the payload, traffic, or sidelink-burst of the sidelink-centric subframe. The sidelink data portion 706 may include the communication resources (e.g., time and/or frequency resources) utilized to communicate sidelink data from one scheduled entity 204 (e.g., UE₁) to one or more other scheduled entities 204 (e.g., UE₂, UE₃). In some configurations, the sidelink data portion 706 may include a physical sidelink shared channel (PSSCH), as indicated in FIG. 7. In some examples, the transmitting scheduled entity 204 may transmit sidelink control information over the resources allocated (e.g., sidelink grants) by the PDCCH 702 before transmitting the sidelink data 706. The sidelink control information provides the information or parameters used by the receiving sidelink device to receive and decode the sidelink data.

The sidelink-centric subframe 700 may also include a common UL portion 708. In some aspects, the common UL portion 708 may be similar to the common UL portion 506, 606 described above with reference to FIGS. 5-6. Notably, as illustrated in FIG. 7, the common UL portion 708 may be included in the end portion of the sidelink-centric subframe. By including the common UL portion 708 in the end portion of the sidelink-centric subframe, the likelihood of interfering with the common UL portion 506, 606 of DL-centric and UL-centric subframes of nominal traffic is minimized or reduced. In other words, because the DL-centric subframe, the UL-centric subframe, and the sidelink-centric subframe have their common UL portions 506, 606, 708 communicated during a similar portion of their respective subframe, the likelihood of interference between those common UL portions 506, 606, 708 is minimized or reduced. That is, the common UL portions 506, 606 of DL-centric and UL-centric subframes (of nominal traffic) are relatively better protected, and less likely to be interfered by DL data.

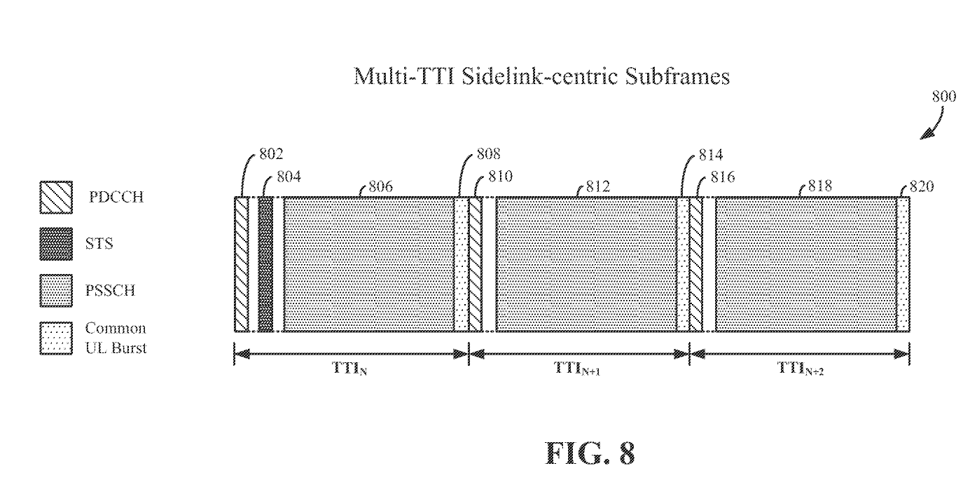

FIG. 8 is a diagram 800 illustrating an example of sidelink-centric subframes extending across a plurality of TTIs. In some configurations, these sidelink-centric subframes may be utilized for broadcast communication. Generally, a TTI refers to a schedulable interval of time that contains at least one transport block. Although the example illustrated in FIG. 8 shows three TTIs (e.g., TTI_{N}, TTI_{N+1}, TTI_{N+2}), one of ordinary skill in the art will understand that any plural number of TTIs may be implemented without deviating from the scope of the present disclosure. The first TTI (e.g., TTI_{N}) may include a control portion 802 (e.g., PDCCH, as described in greater detail above) and an STS portion 804 (as also described in greater detail above). The STS portion 804 may indicate a duration that extends across more than one TTI (e.g., TTI_{N}, TTI_{N+1}, TTI_{N+2}) for sidelink communication. In other words, the STS may indicate a requested duration of time to keep the sidelink channel available for sidelink signals, and that requested duration may extend until the end of the last TTI (e.g., TTI_{N+2}) of a plurality of TTIs (e.g., TTI_{N}, TTI_{N+1}, TTI_{N+2}). Therefore, although the plurality of TTIs (e.g., TTI_{N}, TTI_{N+1}, TTI_{N+2}) each include a sidelink data portion 806, 812, 818, not every TTI requires the STS portion 804. In this example, only the first TTI includes the STS portion 804. By not including the STS portion 804 in every TTI of the plurality of TTIs (e.g., TTI_{N}, TTI_{N+1}, TTI_{N+2}), the overall amount of overhead is relatively lower than it would be otherwise (e.g., if the STS portion 804 was included in every TTI). By reducing overhead, relatively more of the TTIs (e.g., TTI_{N+1}, TTI_{N+2}) lacking the STS portion 804 can be utilized for communication of the sidelink data 812, 818, which thereby increases relative throughput or bandwidth efficiency.

The STS portion 804 may be followed by a sidelink data portion 806 (which is described in greater detail above with reference to the sidelink data portion 706 in FIG. 7). The sidelink data portion 806 may be followed by the common UL portion 808 (which is described in greater detail above with reference to the common UL portion 708 in FIG. 7). In the example illustrated in FIG. 8, every TTI (e.g., TTI_{N+1}, TTI_{N+2}) following the first TTI (e.g., TTI_{N}) includes a control portion 810, 816 at an initial/beginning portion of each subframe/TTI and a common UL portion 814, 820 at the end portion of each subframe/TTI. By providing the control portion 810, 816 at the initial/beginning of each subframe/TTI and providing the common UL portion 814, 820 at the end portion of each subframe/TTI, the sidelink-centric subframes have a structure that minimizes the likelihood of interference with DL/UL control/scheduling information of nominal traffic (as described in greater detail above). In some examples, a gap or guard band may be provided between the common UL portion and the control portion such that the scheduled entity is provided with sufficient time to reconfigure its circuitry between a receiving mode and a transmitting mode.

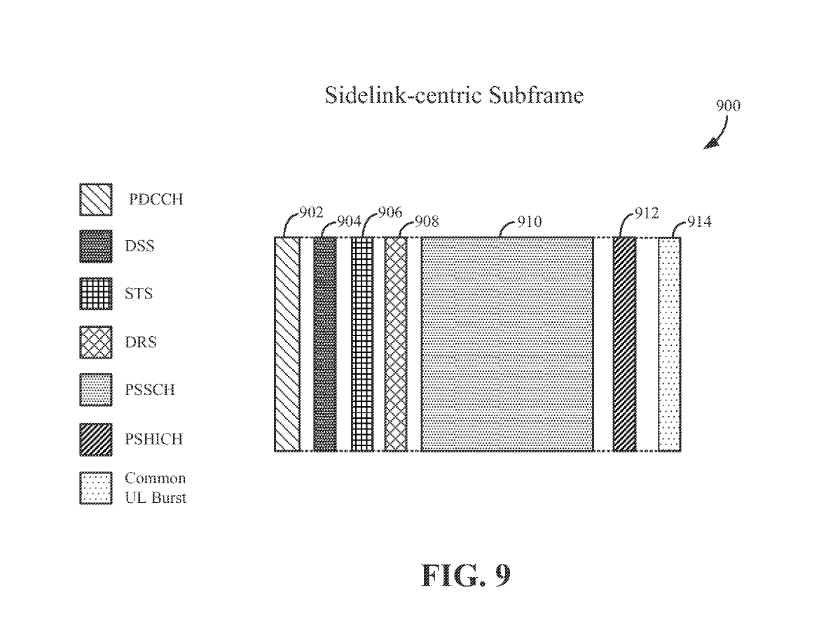

FIG. 9 is a diagram illustrating another example of a sidelink-centric subframe 900 according to some aspects of the present disclosure. In some configurations, this sidelink-centric subframe may be utilized for a unicast communication. A unicast communication may refer to a transmission by a scheduled entity 204 (e.g., UE₁) to a particular scheduled entity 204 (e.g., UE₂). Description corresponding to aspects of the control portion 902, sidelink data portion 910, and common UL portion 914 are provided above with reference to preceding figures, and therefore will not be repeated to avoid redundancy.

The example of the sidelink-centric subframe 900 illustrated in FIG. 9 includes a direction selection signal (DSS) 904, and a source transmit signal (STS) 906. Additional description regarding the STS signal is provided above (e.g., with reference to FIG. 7), and therefore will not be repeated to avoid redundancy. The content of the DSS is substantially similar to that of the STS. However, in contrast to the STS signal described above with respect to FIG. 7, the DSS 904 and STS 906 described herein with reference to FIG. 9 and utilized for unicast communication, may include a destination ID instead of a group destination ID. The destination ID may indicate the specific apparatus or scheduled entity destined to receive the STS/DSS.

For sidelink communication, a primary device may transmit a DSS during the DSS portion 904, and a non-primary device may transmit an STS during the STS portion 906. A primary device may refer to a device that has priority access to the sidelink channel over the non-primary device. During an association phase, one device may be selected as the primary device and another device may be selected as the non-primary (e.g., secondary) device. In some configurations, the primary device may be a relay device that relays a signal from a non-relay device to another device, such as a scheduling entity 202 (e.g., eNB). The relay device may experience relatively less path loss (when communicating with the scheduling entity 202 (e.g., eNB)) relative to the path loss experienced by the non-relay device.

During the DSS portion 904, the primary device may transmit a DSS, and the non-primary device listens for the DSS from the primary device. One the one hand, if the non-primary device detects a DSS during the DSS portion 904, then the non-primary device will not transmit an STS during the STS portion 906. On the other hand, if the non-primary device does not detect a DSS during the DSS portion 904, then the non-primary device may transmit an STS during the STS portion 906. A time gap (e.g., a guard interval, guard band, etc.) between DSS and STS allows the non-primary device to transition from a listening/receiving state (during DSS 904) to a transmitting state (during STS 906).

If the sidelink channel is available for the requested duration of time, an apparatus that receives the DSS/STS may communicate a destination receive signal (DRS) during the DRS portion 908. The DRS may indicate the availability of the sidelink channel for the requested duration of time. The DRS may additionally or alternatively include other information, such as a source ID, a duration of the transmission, a signal to interference plus noise ratio (SINR) (e.g., of the received reference signal (RS) from the source device), an RS to enable TX-yielding, CQI information, and/or various other suitable types of information. The exchange of DSS/STS and DRS (DSS/STS-DRS handshaking) enables the scheduled entities 204 (e.g., UEs) performing sidelink communication to negotiate the availability of the sidelink channel prior to the communication of the sidelink data signal or payload, thereby minimizing the likelihood of interfering sidelink signals. In other words, without the DSS/STS and DRS, two or more scheduled entities 204 (e.g., UEs) may concurrently transmit sidelink signals using the same resources (e.g., time and/or frequency resources) of the sidelink data portion 910, thereby causing a collision and resulting in avoidable retransmissions.

For the sake of completeness, the following information is provided regarding TX-yielding. Assume (again) that two sidelinks exist. Sidelink₁ is between UE_{A} and UE_{B}, and Sidelink₂ is between UE_{C} and UE_{D}. Assume (again) that Sidelink₁ has a higher priority than Sidelink₂. The priority of the sidelinks may be determined by a scheduling entity 202. If UE_{A} and UE_{C} concurrently transmit their respective DSSs, UE_{B} will transmit a DRS (because Sidelink₁ has relatively higher priority than Sidelink₂). In the DRS, UE_{B} may include an RS or a flag that is configured to inform UE_{C} that it may interfere with the sidelink communication (e.g., sidelink signal in the sidelink data portion 910) if it transmits during a particular period of time. Accordingly, by receiving this RS, UE_{C} will refrain from transmitting for that particular period of time (e.g., at least for the duration of the sidelink communication of Sidelink₁). Accordingly, the relatively lower priority sidelink (Sidelink₂) yields communication (i.e., TX-yielding) for a particular period of time under these circumstances.

As described in greater detail above, the sidelink signal or payload may be communicated in the sidelink data portion 910 of the sidelink-centric subframe. In some configurations, the MCS of the sidelink signal communicated in the sidelink data portion 910 may be selected based on the CQI information included in the DRS. After communicating the sidelink signal in the sidelink data portion 910, acknowledgment information may be communicated between the scheduled entities 204 (e.g., UEs). Such acknowledgment information may be communicated in the sidelink acknowledgment portion 912 of the sidelink-centric subframe. Non-limiting examples of such acknowledgment information may include an ACK signal, a NACK signal, a HARQ indicator, and/or various other suitable types of acknowledgment information. For example, after receiving and successfully decoding a sidelink signal from UE₁ in the sidelink data portion 910, UE₂ may transmit an ACK signal to UE₁ in the sidelink acknowledgment portion 912 of the sidelink-centric subframe. In some configurations, the sidelink acknowledgment portion 912 may include a physical sidelink HARQ indicator channel (PSHICH), as indicated in FIG. 9. The sidelink acknowledgment portion 912 may be separated in time from the common UL portion 914 by a guard period. This separation provides time for the switch-over from DL communication to UL communication.

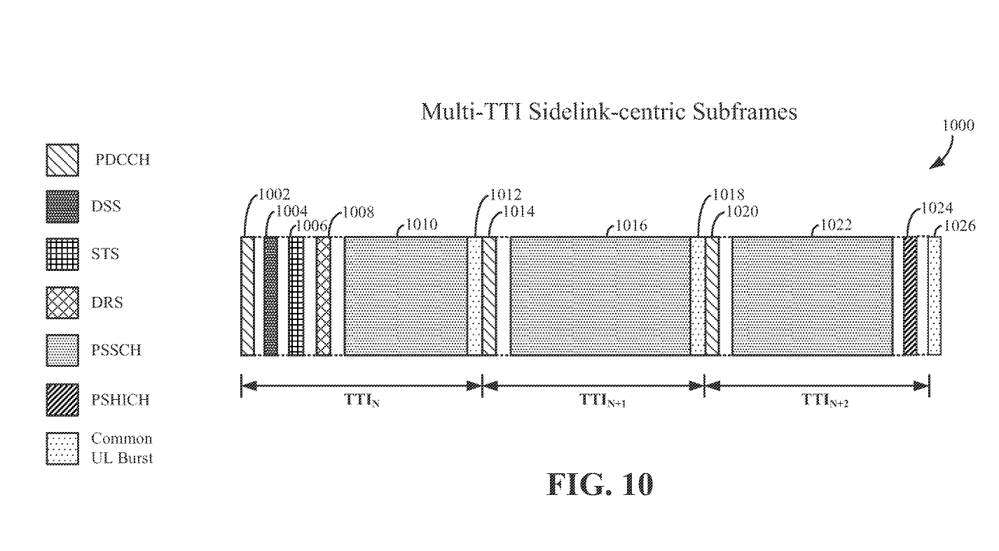

FIG. 10 is a diagram 1000 illustrating an example of sidelink-centric subframes extending across a plurality of TTIs. In some configurations, these sidelink-centric subframes may be utilized for unicast communications. Although the example illustrated in FIG. 10 shows three TTIs (e.g., TTI_{N}, TTI_{N+1}, TTI_{N+2}), one of ordinary skill in the art will understand that any plural number of TTIs may be implemented without deviating from the scope of the present disclosure. The first TTI (e.g., TTI_{N}) may include the control portion 1002 (e.g., PDCCH, as described in greater detail above), a DSS portion 1004, an STS portion 1006, and a DRS portion 1008 (as also described in greater detail above).

The DSS communicated during the DSS portion 1004 and/or the STS communicated during the STS portion 1006 may indicate a duration that extends across more than one TTI (e.g., TTI_{N}, TTI_{N+1}, TTI_{N+2}) for sidelink communication. In other words, the DSS/STS indicates a requested duration of time to keep the sidelink channel available for sidelink signals, and that requested duration extends until the end of the last TTI (e.g., TTI_{N+2}) of the plurality of TTIs (e.g., TTI_{N}, TTI_{N+1}, TTI_{N+2}). If the sidelink channel is available for that requested duration of time, then the DRS may be communicated in the DRS portion 1008 (as described in greater detail above). Although the plurality of TTIs (e.g., TTI_{N}, TTI_{N+1}, TTI_{N+2}) each include a sidelink data portion 1010, 1016, 1022, not every TTI has a DSS/STS portion. By not including a DSS/STS portion in every TTI of the plurality of TTIs (e.g., TTI_{N}, TTI_{N+1}, TTI_{N+2}), the overall amount of communication overhead is relatively lower than it would otherwise (if DSS and/or STS was/were included in every TTI). By reducing overhead, relatively more time of the TTIs (e.g., TTI_{N+1}, TTI_{N+2}) lacking DSS and/or STS can be utilized for communication of the sidelink data 1016, 1022, which thereby increases relative throughput.

DSS 1004, STS 1006, and DRS 1008 may be followed by a first sidelink data portion 1010 (which is described in greater detail above with reference to the sidelink data portion 706 in FIG. 7). The sidelink data portions 1010, 1016, 1022 may each be followed by a common UL portion 1012, 1018, 1026 (which are described in greater detail above with reference to the common UL portion 708 in FIG. 7). In the example illustrated in FIG. 10, every TTI (e.g., TTI_{N+1}, TTI_{N+2}) following the first (e.g., TTI_{N}) includes a control portion 1014, 1020 at an initial/beginning portion of each subframe/TTI and a common UL portion 1018, 1026 at the end portion of each subframe/TTI. By providing the control portion 1014, 1020 at the initial/beginning of each subframe/TTI and providing the common UL portion 1018, 1026 at the end portion of each subframe/TTI, the sidelink-centric subframes have a structure that minimizes the likelihood of interference with DL/UL control/scheduling information of nominal traffic (as described in greater detail above).

In the example illustrated in FIG. 10, the sidelink-centric subframes include a single sidelink acknowledgment portion 1024 in a last/final TTI (e.g., TTI_{N+2}) of the plurality of TTIs (e.g., TTI_{N}, TTI_{N+1}, TTI_{N+2}). The sidelink acknowledgment portion 1024 may be separated in time from a common UL portion 1026 by a guard period. This separation provides time for the switch-over from DL communication to UL communication. The acknowledgment information communicated in the sidelink acknowledgment portion 1024 in the last/final TTI (e.g., TTI_{N+2}) may correspond to the sidelink signals included in one or more preceding sidelink data portions 1010, 1016, 1022. For example, the sidelink acknowledgment portion 1024 may include a HARQ identifier corresponding to sidelink signals communicated throughout the sidelink data portions 1010, 1016, 1022 of the plurality of TTIs (e.g., TTI_{N}, TTI_{N+1}, TTI_{N+2}). Because the sidelink acknowledgment portion 1024 is not included in every TTI (e.g., TTI_{N}, TTI_{N+1}), the overall amount of overhead is relatively lower than it would be otherwise (e.g., if sidelink acknowledgment portion 1024 were included in every TTI). By reducing overhead, relatively more of the TTIs (e.g., TTI_{N}, TTI_{N+1}) lacking the sidelink acknowledgment portion 1024 can be utilized for communication of sidelink data or payload, which thereby increases relative throughput. However, one of ordinary skill in the art will readily understand that the example illustrated in FIG. 10 is non-limiting and alternative configurations may exist without necessarily deviating from the scope of the present disclosure.

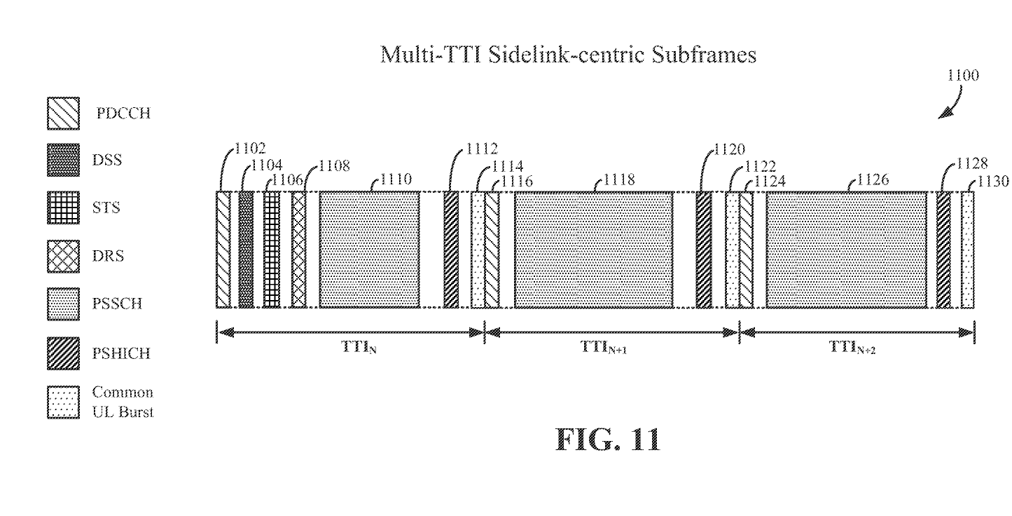

FIG. 11 is a diagram 1100 illustrating an example of such an alternative configuration. Various aspects illustrated in FIG. 11 (e.g., control portions 1102, 1116, 1124; DSS portion 1104; STS portion 1106; DRS portion 1108; and common UL portions 1114, 1122, 1130) are described above with reference to FIG. 10 and therefore will not be repeated here to avoid redundancy. An aspect in which the example illustrated in FIG. 11 may differ from the example illustrated in FIG. 10 is that the example in FIG. 11 includes a sidelink acknowledgment portion 1112, 1120, 1128 (shown as PSHICH in FIG. 11 for example) in every TTI of the plurality of TTIs (e.g., TTI_{N}, TTI_{N+1}, TTI_{N+2}). The sidelink acknowledgment portion may be separated in time from a common UL portion by a guard period. This separation provides time for the switch-over from DL communication to UL communication. For example, each sidelink acknowledgment portion 1112, 1120, 1128 may respectively communicate acknowledgment information corresponding to a sidelink signal or payload included in the corresponding sidelink data portion 1110, 1118, 1126 in its TTI. By receiving acknowledgment information corresponding to the sidelink signal in that particular or same TTI, the scheduled entity 204 (e.g., UE) may obtain relatively better specificity regarding the communication success of each sidelink signal per TTI. For example, if only one sidelink signal in a single sidelink data portion (e.g., sidelink data portion 1110) is not successfully communicated, retransmission can be limited to only the affected sidelink portion (e.g., sidelink data portion 1110) without the burden of retransmitting unaffected sidelink portions (e.g., other sidelink data portions 1118, 1126).

FIG. 12 is a diagram illustrating an interference scenario between sidelinks extending across multiple subframes/TTIs. For example, a first scheduled entity 204 (e.g., UE_{A}) transmits sidelink data to a second scheduled entity 204 (e.g., UE_{B}) using a first sidelink 1200 across multiple TTIs (two exemplary TTIs shown in FIG. 12). The DSS/STS-DRS handshaking 1202 in the first TTI (e.g., TTI_{N}) informs neighboring scheduled entities 204 (e.g., UE_{C}, UE_{D}) of channel occupation by the first sidelink for a certain number of TTIs. In the second TTI (e.g., TTI_{N+1}), a third scheduled entity 204 (e.g., UE_{C}) may have data to transmit to a fourth scheduled entity 204 (e.g., UE_{D}). Therefore, UE_{C} and UE_{D} may perform DSS/STS-DRS handshaking 1204 during TTI_{N+1} to establish a second sidelink 1203. Based on the DSS/STS-DRS handshaking 1202 between UE_{A} and UE_{B}, UE_{C} may determine that its DSS transmission will not significantly interfere with UE_{B}'s reception of sidelink data 1206 of the first sidelink. UE_{C} could have received UE_{B}'s DRS in the previous subframe, from which UE_{C} can determine if it needs to perform Tx-yielding. Upon receiving UE_{C}'s DSS, UE_{D} may determine that it needs not perform Rx-yielding and thus transmits DRS 1208 to UE_{C}. UE_{D} could have determined that its transmission will not cause interference based on the DSS and/or STS of first sidelink 1200 in a previous subframe. However, in this case, UE_{C} may not be able to receive and/or decode the DRS 1208 due to the simultaneously ongoing sidelink data 1206 transmission on the first sidelink 1200.

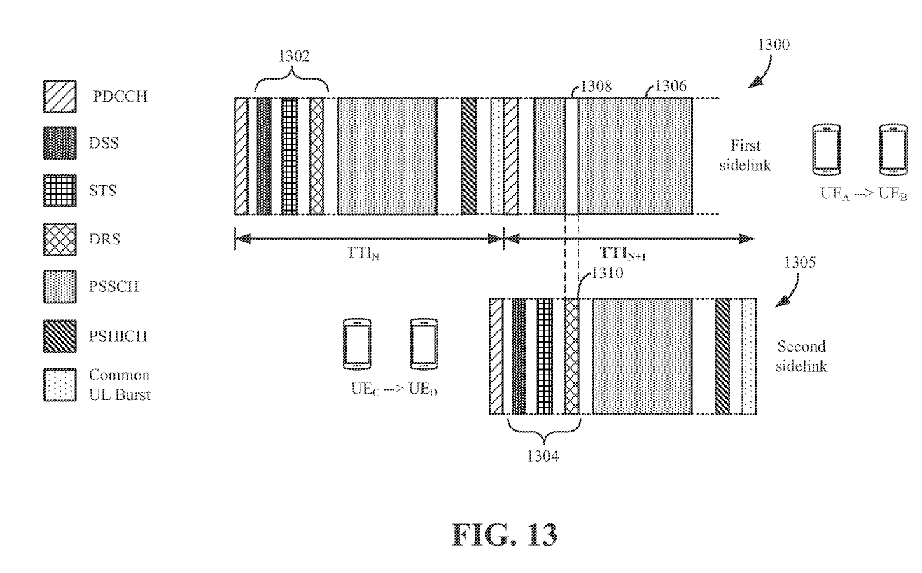

Aspects of the present disclosure provide solutions that can reduce or avoid the sidelink interference problems described in relation to FIG. 12. FIG. 13 is a diagram illustrating a destination receive signal (DRS) protection scheme using data puncturing according to some aspects of the present disclosure. Referring to FIG. 13, a first scheduled entity 204 (e.g., UE_{A}) transmits data to a second scheduled entity 204 (e.g., UE_{B}) using a first sidelink 1300 across multiple TTIs (e.g., two exemplary TTIs shown in FIG. 13). The DSS/STS-DRS handshaking 1302 in the first TTI (e.g., TTI_{N}) informs neighboring scheduled entities 204 (e.g., UE_{C} and UE_{D}) of channel occupation by the first sidelink 1300 for a certain number of TTIs. In the second TTI (e.g., TTI_{N+1}), a third scheduled entity 204 (e.g., UE_{C}) may have data to transmit to a fourth scheduled entity 204 (e.g., UE_{D}). Therefore, UE_{C} and UE_{D} may perform DSS/STS-DRS handshaking 1304 during TTI_{N+1} to establish a second sidelink 1305.

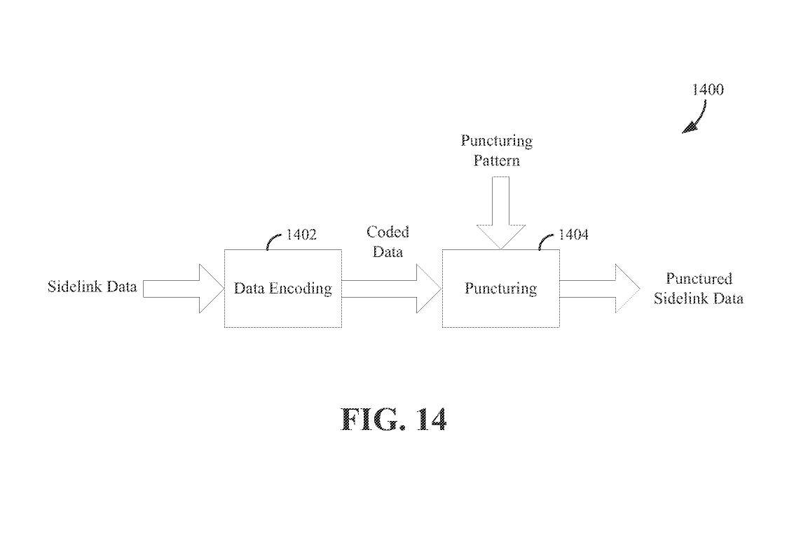

In the second TTI, UE_{A} may puncture its PSSCH data 1306 (sidelink data portion or payload) during a predetermined time period 1308 when UE_{C} receives the DRS 1310 from UE_{D}. That is, the predetermined time period 1308 overlaps the DRS 1310. Puncturing in this example means that UE_{A} does not transmit data during the predetermined time period 1308 such that UE_{C} can receive the DRS from UE_{D} without being interfered by transmission of the first sidelink 1300. In one aspect of the disclosure, referring to FIG. 14, UE_{A} may encode 1402 its sidelink data using a certain coding technique (e.g., convolutional coding) to produce coded data that can be modulated for sidelink transmission. Then, puncturing 1404 may take certain data bit(s) out of the coded data according to a predetermined puncturing pattern. For example, puncturing may include, dropping, discarding, or not transmitting certain coded bit(s) that may overlap the DRS portion 1310. The location and timing of DRS in each subframe/TTI is known because this information may be included in the sidelink grant information broadcasted (e.g., PDCCH) by a scheduling entity 202 or base station (e.g., eNB). Therefore, the puncturing pattern may be determined based on the DRS timing.

In various aspects of the disclosure, UE_{A} may puncture data in all or some of the TTIs after the first TTI (e.g., TTI_{N}) in any predetermined order. For example, the UE_{A} may puncture its sidelink data in a certain TTI when it detects a sidelink channel nearby that may be interfered by its sidelink data transmission.

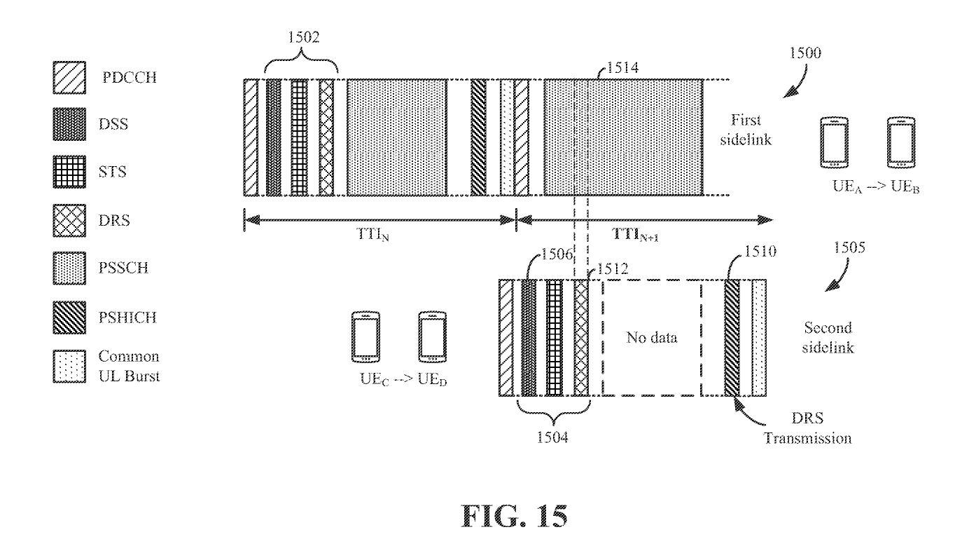

FIG. 15 is a diagram illustrating an example of a destination receive signal (DRS) protection scheme using retransmission according to some aspects of the present disclosure. Referring to FIG. 15, a first scheduled entity 204 (e.g., UE_{A}) transmits data to a second scheduled entity 204 (e.g., UE_{B}) using a first sidelink 1500 across multiple TTIs (e.g., two TTIs shown in FIG. 15). The DSS/STS-DRS handshaking 1502 in the first TTI (e.g., TTI_{N}) informs neighboring scheduled entities 204 (e.g., UE_{C} and UE_{D}) of channel occupation by the first sidelink 1500 for a certain number of TTIs. In the second TTI (e.g., TTI_{N+1}), a third scheduled entity 204 (e.g., UE_{C}) may have data to transmit to a fourth scheduled entity 204 (e.g., UE_{D}). Therefore, UE_{C} and UE_{D} may perform DSS/STS-DRS handshaking 1504 during TTI_{N+1} to establish a second sidelink 1505. UE_{C} may monitor the DSS, STS and/or DRS of other sidelinks (e.g., first sidelink 1500) to determine whether UE_{A} will transmit sidelink data on the first sidelink 1500. If UE_{A} transmits sidelink data during TTI_{N+1}, UE_{C} may be blocked or interfered by the first sidelink 1500 to receive and/or decode the DRS 1512 (first DRS) in the time period 1514 that overlaps the DRS transmission. When UE_{C} is aware that neighboring UE_{A} will be transmitting sidelink data in the second TTI (e.g., TTI_{N+1}), UE_{C} may include a flag in its DSS signal 1506 to indicate potential sidelink interference. The flag may be one or more bits configured to request UE_{D} to retransmit all or some of the information of DRS 1512 during the same TTI (e.g., TTI_{N+1}). For example, UE_{D} in response to the flag, may retransmit DRS-equivalent information (second DRS) with a CQI in the PSHICH 1510 (or an acknowledgment portion of the TTI) where there is no sidelink data transmission from UE_{A}. In the case that UE_{C} cannot receive and/or decode the DRS 1512, UE_{C} will not transmit data during this TTI. However, UE_{C} can send its payload data in subsequent TTI(s).

In some aspects of the disclosure, an apparatus (e.g., UE) may be configured to perform either one or both of the DRS protection schemes described above in relation to the FIGS. 13 and 15. That is, the apparatus may be configured to puncture its sidelink data during a predetermined time period to reduce interference to a DRS transmission of a different sidelink, and/or retransmit DRS-equivalent information (e.g., a second DRS) with a CQI in a PSHICH where there is no data transmission from an otherwise interfering sidelink.

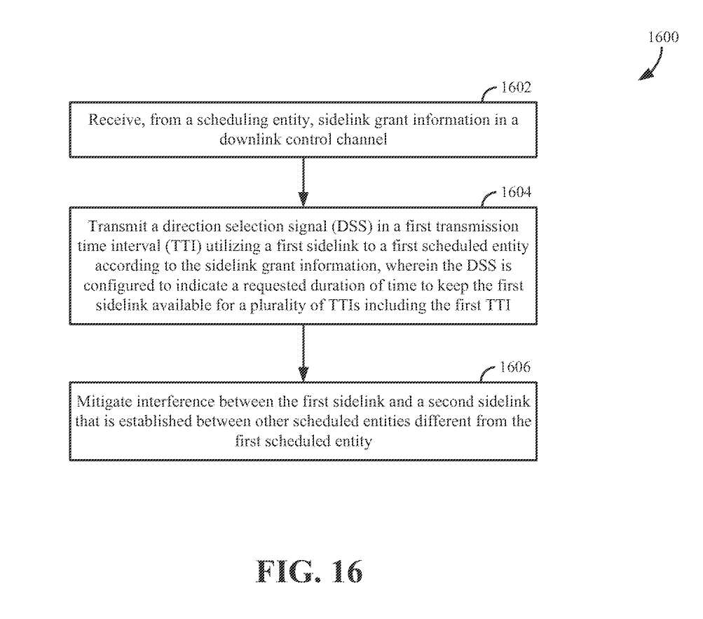

FIG. 16 is a flowchart illustrating a method 1600 of sidelink interference management according to some aspects of the present disclosure. The method of FIG. 16 may be implemented or executed using any of the scheduled entities 204 or UEs to manage sidelink interference for example as described in relation to FIGS. 13-15. At block 1602, a scheduled entity 204 may utilize the communication interface 410 to receive, from a scheduling entity, sidelink grant information in a downlink control channel (e.g., PDCCH). For example, the scheduling entity may be any of the eNBs or scheduling entities described in FIGS. 1-3 or another scheduled entity.

At block 1604, the scheduled entity may utilize the sidelink communication block 440 to transmit a DSS in a first TTI utilizing a first sidelink to a first scheduled entity according to the sidelink grant information. The DSS is configured to indicate a requested duration of time to keep the first sidelink available for a plurality of TTIs including the first TTI. In one example, the scheduled entity may be UE_{A} of FIG. 13 or 15 that transmits a DSS to UE_{B} using the first sidelink (e.g., sidelink 1300 or 1500). In another example, the scheduled entity may be the UE_{C} of FIG. 13 or 15 that transmits a DSS to UE_{D} using the second sidelink (e.g., sidelink 1305 or 1505).

At block 1606, the scheduled entity may utilize the sidelink interference control block 446 to mitigate interference between the first sidelink and a second sidelink established between other scheduled entities different from the scheduled entity and the first scheduled entity. In one example, when the first sidelink is the sidelink 1300 or 1500, the second sidelink may be the sidelink 1305 or 1505. In another example, when the first sidelink is the sidelink 1305 or 1505, the second sidelink may be the sidelink 1300 or 1500. In one example, to mitigate interference between the sidelinks, the scheduled entity (e.g., UE_{A} of FIG. 13) may configure the sidelink interference control block 446 to puncture its sidelink data during a first time period (e.g., time period 1308) of at least one of the TTIs, wherein the first time period overlaps with a first DRS (e.g., DRS 1310) of the second sidelink. In another example, to mitigate interference between the sidelinks, the scheduled entity (e.g., UE_{C} of FIG. 15) may configure the sidelink interference control block to include a flag in its DSS signal to receive, from the first scheduled entity (e.g., UE_{D}) in the first TTI, a retransmission of a second DRS in a second time period (e.g., time period 1510) that is not interfered by the second sidelink.

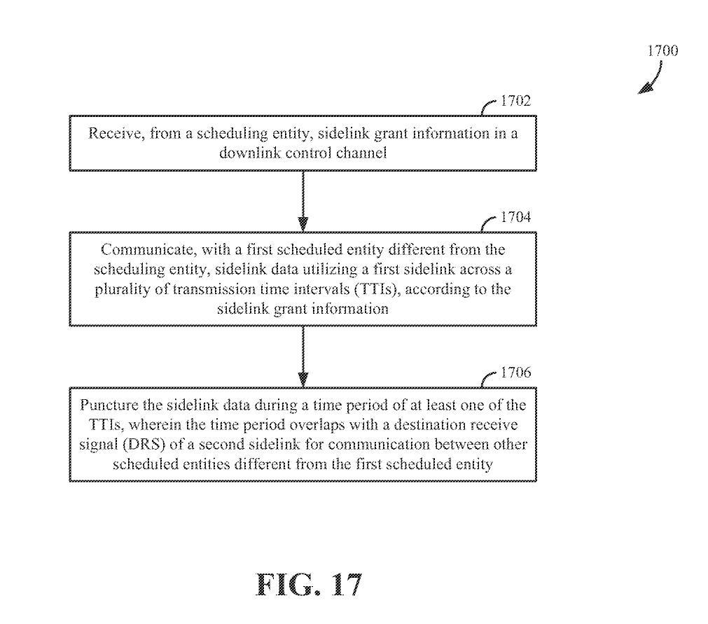

FIG. 17 is a flowchart illustrating a method 1700 of sidelink interference management according to some aspects of the present disclosure. The method of FIG. 17 may be implemented or executed using any of the scheduled entities 204 or UEs to manage sidelink interference, for example, as described in relation to FIG. 13. At block 1702, a scheduled entity 204 (e.g., UE_{A} of FIG. 13) utilizes the communication interface 410 to receive, from a scheduling entity, sidelink grant information in a downlink control channel (e.g., PDCCH). For example, the scheduling entity may be any of the eNBs or scheduling entities described in FIGS. 1-3 or another scheduled entity. At block 1704, the scheduled entity may utilize the sidelink communication block 440 to communicate, with a first scheduled entity (e.g., UE_{B} of FIG. 13) different from the scheduling entity, sidelink data (e.g., PSSCH data 1306) utilizing a first sidelink (e.g., first sidelink 1300) across a plurality of TTIs, according to the sidelink grant information. At block 1706, the scheduled entity (e.g., UE_{A}) may utilize the sidelink interference control block 446 configured to puncture its sidelink data during a predetermined time period (e.g., time period 1308 of FIG. 13) of at least one of the TTIs, wherein the time period overlaps with a DRS (e.g., DRS 1310 of FIG. 13) of a second sidelink for communication between other scheduled entities (e.g., UE_{C} and UE_{D}) different from the first scheduled entity (e.g., UE_{B}). Therefore, interference with the DRS may be reduced or avoided.

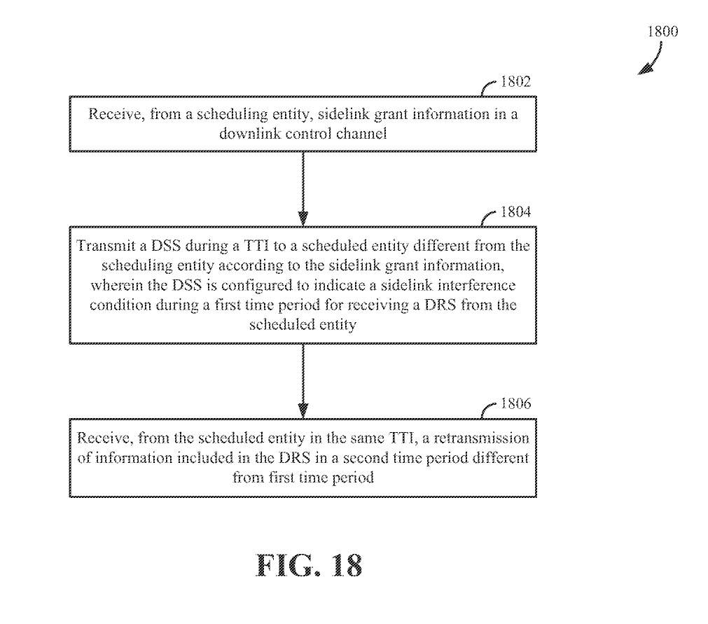

FIG. 18 is a flowchart illustrating a method 1800 of sidelink interference management according to some aspects of the present disclosure. The method of FIG. 18 may be implemented or executed using any of the scheduled entities 204 or UEs to manage sidelink interference, for example, as described in relation to FIG. 15. At block 1802, a scheduled entity 204 (e.g., UE_{C} of FIG. 15) utilizes the transceiver 410 to receive, from a scheduling entity, sidelink grant information in a downlink control channel (e.g., PDCCH). At block 1804, the UE_{C} utilizes the sidelink interference control block 446 configured to transmit a DSS (e.g., DSS 1506 of FIG. 15) during a TTI to a scheduled entity (e.g., UE_{D} of FIG. 15) different from the scheduling entity according to the sidelink grant information. The DSS signal is configured to indicate a sidelink interference condition during a time period (e.g., time period 1514 of FIG. 15) for receiving a DRS (e.g., DRS 1512 of FIG. 15) from the UE_{D}. At block 1806, UE_{C} utilizes the sidelink communication block 440 and/or sidelink interference control block to receive, from UE_{D} in the same TTI, a retransmission (a second DRS) of the information included in the first DRS in a time period (e.g., acknowledgment portion 1510 of FIG. 15) different from that for receiving the first DRS. Therefore, even if UE_{C} failed to receive and/or decode the first DRS 1512, the information included in the second DRS may still be received during its retransmission for example in the acknowledgment portion 1510 (e.g., PSHICH) of the same TTI.

In some configurations, the term(s) ‘communicate,’ ‘communicating,’ and/or ‘communication’ may refer to ‘receive,’ ‘receiving,’ ‘reception,’ and/or other related or suitable aspects without necessarily deviating from the scope of the present disclosure. In some configurations, the term(s) ‘communicate,’ ‘communicating,’ ‘communication,’ may refer to ‘transmit,’ ‘transmitting,’ ‘transmission,’ and/or other related or suitable aspects without necessarily deviating from the scope of the present disclosure.

Although the examples described herein may describe certain features, operations, processes, methods, and/or aspects from the perspective of a scheduled entity 204 (e.g., UE), one of ordinary skill in the art will understand that corresponding features, operations, processes, methods, and/or aspects from the perspective of the scheduling entity 202 (e.g., base station, cell, and/or other network entity) are readily ascertainable and understood from the present disclosure and, therefore, would not deviate from the scope of the present disclosure. Several aspects of a wireless communication network have been presented with reference to an exemplary implementation. As those skilled in the art will readily appreciate, various aspects described throughout this disclosure may be extended to other telecommunication systems, network architectures and communication standards. By way of example, various aspects may be implemented within other systems defined by 3GPP, such as LTE, the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated herein may be rearranged and/or combined into a single component, step, feature or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

What is claimed is:

1. A method of communication by an apparatus, the method comprising:
receiving, from a scheduling entity, sidelink grant information in a downlink control channel;
transmitting a direction selection signal (DSS) in a first transmission time interval (TTI) utilizing a first sidelink to a first scheduled entity according to the sidelink grant information, wherein the DSS is configured to indicate a requested duration of time to keep the first sidelink available for a plurality of TTIs including the first TTI;
mitigating interference between the first sidelink and a second sidelink established between other scheduled entities different from the first scheduled entity, comprising at least one of:
puncturing sidelink data of the first sidelink during a first time period of at least one of the TTIs, wherein the first time period overlaps with a first destination receive signal (DRS) of the second sidelink; or
receiving, from the first scheduled entity in the first TTI, a retransmission of a second DRS in a second time period that is not interfered by the second sidelink.

2. The method of claim 1, further comprising:
puncturing the sidelink data in a second TTI of the plurality of TTIs after the first TTI.

3. The method of claim 1, further comprising:
puncturing the sidelink data in two or more of the plurality of TTIs.

4. The method of claim 1, wherein the puncturing the sidelink data comprises avoiding transmitting sidelink data during the first time period.

5. The method of claim 1, wherein the DSS is configured to indicate potential sidelink interference during a third time period for receiving the second DRS from the first scheduled entity.

6. The method of claim 5, wherein the DSS comprises a flag configured to request the first scheduled entity to retransmit the second DRS.

7. The method of claim 1, wherein the receiving the retransmission of the second DRS comprises receiving the second DRS in an acknowledgment portion of the first TTI.

8. An apparatus for wireless communication, comprising:
a communication interface configured to communicate with a scheduling entity, a first scheduled entity, and a second scheduled entity;
a memory stored with executable code; and
a processor operatively coupled with the communication interface and the memory,
wherein the processor is configured by the executable code to:
receive, from the scheduling entity, sidelink grant information in a downlink control channel;
transmit a direction selection signal (DSS) in a first transmission time interval (TTI) utilizing a first sidelink to the first scheduled entity according to the sidelink grant information, wherein the DSS is configured to indicate a requested duration of time to keep the first sidelink available for a plurality of TTIs including the first TTI;
mitigate interference between the first sidelink and a second sidelink established between other scheduled entities different from the first scheduled entity, comprising at least one of:
puncture sidelink data of the first sidelink during a first time period of at least one of the TTIs, wherein the first time period overlaps with a first destination receive signal (DRS) of the second sidelink; or
receive, from the first scheduled entity in the first TTI, a retransmission of a second DRS in a second time period that is not interfered by the second sidelink.

9. The apparatus of claim 8, wherein the processor is further configured to:
puncture the sidelink data in a second TTI of the plurality of TTIs after the first TTI.

10. The apparatus of claim 8, wherein the processor is further configured to:
puncture the sidelink data in two or more of the plurality of TTIs.

11. The apparatus of claim 8, wherein the processor is further configured to puncture the sidelink data by avoiding transmitting sidelink data during the first time period.

12. The apparatus of claim 8, wherein the DSS is configured to indicate potential sidelink interference during a third time period for receiving the second DRS from the first scheduled entity.

13. The apparatus of claim 12, wherein the DSS comprises a flag configured to request the first scheduled entity to retransmit the second DRS.

14. The apparatus of claim 8, wherein the processor is further configured to:
receive the second DRS in an acknowledgment portion of the first TTI.

15. An apparatus for wireless communication, comprising:
means for receiving, from a scheduling entity, sidelink grant information in a downlink control channel;
means for transmitting a direction selection signal (DSS) signal in a first transmission time interval (TTI) utilizing a first sidelink to a first scheduled entity according to the sidelink grant information, wherein the DSS is configured to indicate a requested duration of time to keep the first sidelink available for a plurality of TTIs including the first TTI;
means for mitigating interference between the first sidelink and a second sidelink established between other scheduled entities different from the first scheduled entity, wherein the means for mitigating interference is configured to at least one of:
puncture sidelink data of the first sidelink during a first time period of at least one of the TTIs, wherein the first time period overlaps with a first destination receive signal (DRS) of the second sidelink; or
receive, from the first scheduled entity in the first TTI, a retransmission of a second DRS in a second time period that is not interfered by the second sidelink.

16. The apparatus of claim 15, wherein the means for mitigating interference is further configured to:
puncture the sidelink data in a second TTI of the plurality of TTIs after the first TTI.

17. The apparatus of claim 15, wherein the means for mitigating interference is further configured to:
puncturing the sidelink data in two or more of the plurality of TTIs.

18. The apparatus of claim 15, wherein the DSS is configured to indicate potential sidelink interference during a third time period for receiving the second DRS from the first scheduled entity.

19. The apparatus of claim 18, wherein the DSS comprises a flag configured to request the first scheduled entity to retransmit the second DRS.

20. The apparatus of claim 15, wherein the means for mitigating interference is further configured to receive the second DRS in an acknowledgment portion of the first TTI.
